(19) United States
(12) Patent Application Publication
(10) Pub. No.: US 2002/0114336 A1
(43) Pub. Date: Aug. 22, 2002

(54) Gateway apparatus for performing communication between WAN and LAN

(76) Inventor: Yu-chun Chow, Shinchu (TW)

Correspondence Address: CAMILLE MAYER, 8288 STATE PARK, CENTERLINE, MI, 48015

(21) Appl. No.: 09/836,104

(22) Filed: Apr. 17, 2001

(30) Foreign Application Priority Data
Feb. 21, 2001 (TW) 90103978

(51) Int. Cl. H04L 12/28

(52) U.S. Cl. 370/401; 370/412

(57) ABSTRACT

A gateway apparatus is used in performing communication between local area networks (LAN) and wide area networks (WAN) is provided. The gateway apparatus includes a plurality of input/output ports for connecting the WAN with the LAN, a buffer device for accessing packets which has a transporting path selected from sending the packets from the WAN to the LAN and sending the packets from the LAN to the WAN, a plurality of medium access control units corresponding to said input/output ports and electrically connected between the buffer device and the input/output ports for performing an accessing operation between the buffer device and the input/output ports, a memory device electrically connected to the buffer device for storing the packets sent from the buffer device and a central processing unit electrically connected between the memory device and the medium access control units for processing the packets stored in the memory device, and organizing the medium access control units to change the input/output ports according to a required transporting path, thereby performing the communication between the LAN and the WAN.

### FIELD OF THE INVENTION

The present invention relates to a gateway apparatus. More specifically, the present invention relates to a gateway apparatus capable of transporting packets between wide area networks (WAN) and local area networks (LAN).

### BACKGROUND OF THE INVENTION

When “internet” is more widely used in public, the requirements for connecting and communicating between smaller local area networks (LAN), i.e. a small company or an ordinary family which has many computers connected in a local area, and broader wide area networks (WAN) are increased day-by-day. Referring to FIG. 1, a small LAN 11 is connected with a WAN 12. To simplify and function the connection and the communication between the LAN and WAN, a gateway device 13 is often performed to concurrently address the functions of a router and a firewall.

FIG. 2 is a schematic block diagram of illustrating the function and the connection of a gateway apparatus according to the prior art. The operating method of the conventional gateway apparatus includes the following steps:

(1) a LAN port 111 receives a packet which is to be transported to a WAN 12;

(2) a medium access controller units 112 corresponding to the LAN port 111 disposed in the LAN will be used to transport the packet into a local buffer 114 by a buffer manager 113 in the LAN;

(3) a bus interface controller (BIC) 115 in the LAN will send a request to an internal bus 14 for moving the packet to a memory controller 15 and further storing the packet into a memory 16;

(4) a central processing unit 17 will process the packet via the memory controller 15 to accomplishing the functions of a router and a firewall;

(5) another BIC 125 in the WAN 125 will send a request to the internal bus 14 and transport the processed packet through the memory controller 15 via the internal bus 14 into a local buffer 124 in the WAN by the memory 16;

(6) accessing the packet from the local buffer 124 by another buffer manager 123 in the WAN and sending the packet to the WAN through a medium access control unit 122 via a WAN port 121; and

(7) when other packets are intended to be transported from the WAN to the LAN, the steps of transporting are performed by inversing the above steps.

As can be seen in FIG. 1 and FIG. 2, the conventional gateway shown needs two different internal components and performing method to transport packets between the WAN and the LAN. Moreover, the conformations and the circuit designs in the conventional gateway are too complicated for users to regulate the performing state when the gateway apparatus is operated in actual transporting situation.

It is attempted by the applicant to provide a gateway apparatus to overcome the problems described above for reducing the components in the gateway apparatus and regulating transporting situation between the WAN and the LAN.

### SUMMARY OF THE INVENTION

It is therefore an object of the present invention to provide a gateway device for reducing the components used in an conventional gateway device.

According to the present invention, the gateway apparatus is used in performing communication between wide area networks (WAN) to local area networks (LAN). The gateway apparatus includes a plurality of input/output ports for connecting the WAN with the LAN, a buffer device for accessing packets which has a transporting path of said packets selected from one of sending said WAN to the LAN and sending the packets from the LAN to the WAN, a plurality of medium access control units corresponding to the input/output ports and electrically connected between the buffer device and the input/output ports for performing an accessing operation between the buffer device and the input/output ports, a memory device electrically connected to the buffer device for storing the packets sent from the buffer device and a central processing unit electrically connected between the memory device and the medium access control units for processing the packets stored in the memory device, and organizing the medium access control units to change the input/output ports according to a required transporting path, thereby performing the communication between the LAN and the WAN.

Preferably, the buffer device includes a buffer for temporally storing the packets and a buffer manager electrically connected to the buffer for managing an accessing operation of the buffer device.

Preferably, the memory device includes a memory for storing the packets sent from the buffer device and a memory controller electrically connected to the memory for controlling an accessing operation of the memory.

Preferably, the memory is a dynamic random accessing memory (DRAM).

Preferably, the gateway apparatus further has an internal bus electrically connected to the memory controller for transporting the packets and an bus interface controller electrically connected between the buffer device and the internal bus for controlling a transporting operation in the internal bus so as to complete an packet transporting operation between the buffer device and the internal bus.

Preferably, the medium access control units and the central processing unit are disposed in one identical chip.

Preferably, the central processing unit is used for processing the packets stored in the memory device to achieve functions of a router and a firewall.

A better understanding of the present invention can be obtained when the following detailed description of a preferred embodiment is considered in conjunction with the following drawings, in which:

### BRIEF DESCRIPTION OF THE DRAWINGS

FIG. 1 is a schematic view showing the connection between a small LAN 11 and a WAN 12 in a conventional gateway;

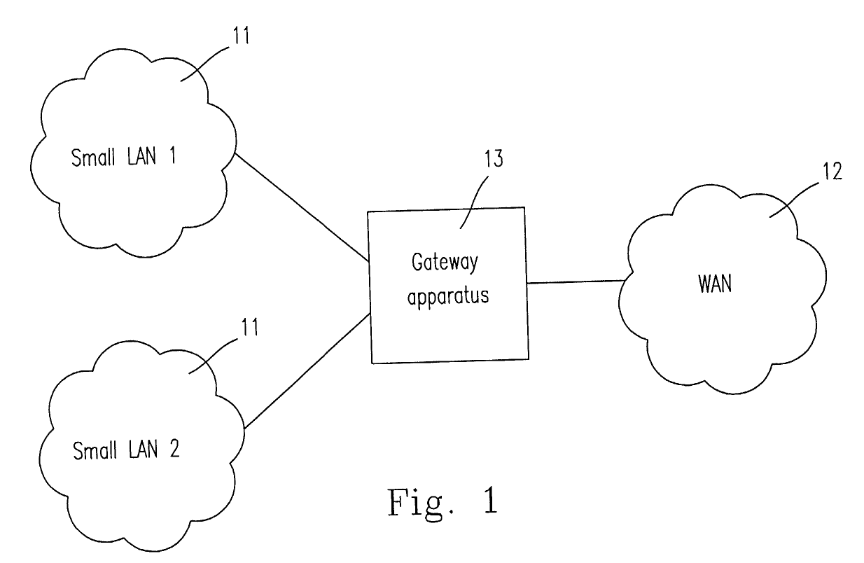

FIG. 2 is schematic block diagram illustrating the function and the connection of a conventional gateway apparatus according to the prior art; and

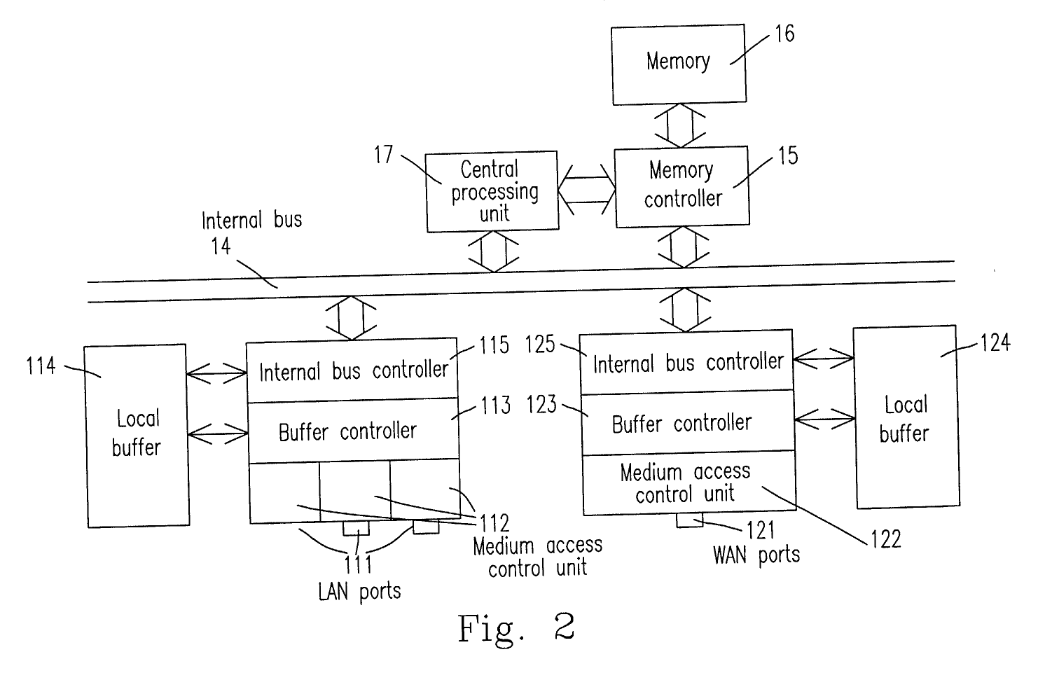

FIG. 3 is a schematic block diagram illustrating the function and the connection of a gateway apparatus according to the preferred embodiment of the present invention;

### DETAILED DESCRIPTION OF THE PREFERRED EMBODIMENTS

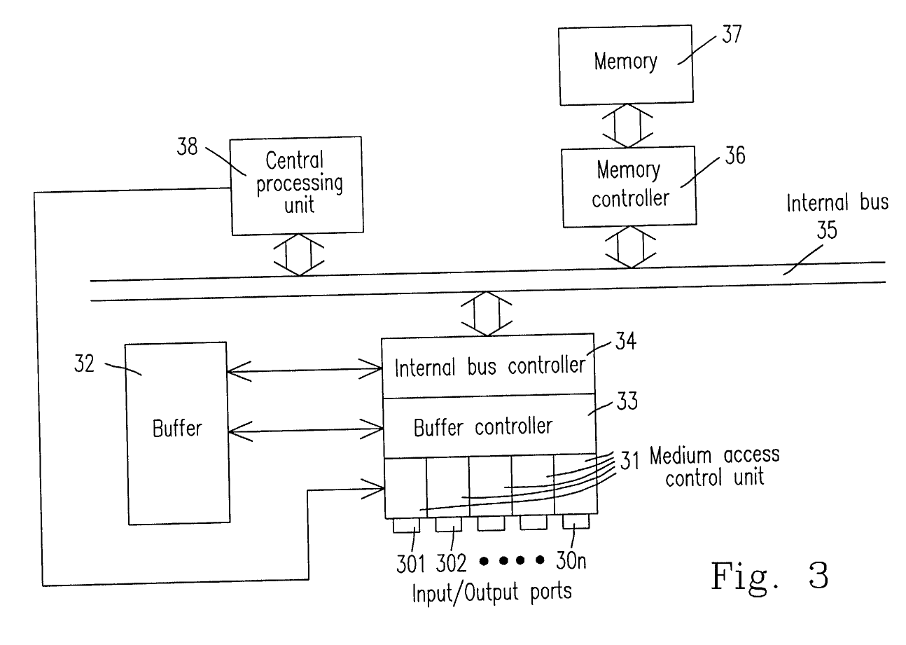

Referring to FIG. 3, the schematic block diagram illustrates the function and the connection of a preferred gateway apparatus according to the present invention. As can be seen in FIG. 3, N input/output ports are used for connecting the LAN with WAN. A plurality of medium access control units 31 corresponding to the respective of input/output ports, i.e. input/output port 301 to input/output port 30n, are disposed in the gateway apparatus. The property of the respective of input/output ports can be changed according to the user's definition and can be shared to a buffer 32, a buffer manager 33 and an internal bus controller 34 so as to process the transport and store of packets in the gateway.

The descriptions described below illustrate a situation that input/output port 301 and input/output port 302 is defined as the ports in the WAN and LAN. When a packet is received to be transported from the LAN to the WAN, the operating method according to the present invention could include the following steps:

(1) receiving a packet to be transported from a LAN port 301 to a certain WAN;

(2) a medium access controller units 31 will be used to transport the packet into a shared local buffer 32 by a shared buffer manager 33;

(3) sending a request to an internal bus 35 by a shared bus interface controller (BIC) 34 for moving the packet to a memory controller 36 and further storing the packet into a memory 37 through the internal bus 35;

(4) processing the packet through the memory controller 36 by a central processing unit 38, thereby achieving the functions of a router and a firewall;

(5) sending a request to the internal bus 35 by a shared BIC 34 and transporting the packet by the memory 37 through the memory controller 36 via the internal bus 35 into the shared local buffer 32; and

(6) accessing the packet from the shared local buffer 32 by a shared buffer manager 33 and sending the packet to the WAN through the medium access control unit 31.

On the other hand, when the input/output port 301 and input/output port 302 is respectively defined as the ports in the WAN and LAN and a packet is received to be transported from the WAN to the LAN, and the operating method could include the following steps:

(1) receiving a packet to be transported from a WAN port 302 to a certain LAN;

(2) a medium access controller units 31 will be used to transport the packet into a shared local buffer 32 through a shared buffer manager 33;

(3) sending a request to an internal bus 35 by a shared bus interface controller (BIC) 34 for moving the packet to a memory controller 36 and further storing the packet into a memory 37 through the internal bus 35;

(4) processing the packet through the memory controller 36 by a central processing unit 38, thereby achieving the functions of a router and a firewall;

(5) sending a request to the internal bus 35 by the shared BIC 34 and transporting the packet by the memory 37 through the memory controller 36 via the internal bus 35 into the shared local buffer 32; and

(6) accessing the packet from the shared local buffer 32 by a shared buffer manager 33 and sending the packet to the LAN through the medium access control unit 31.

The memory 37 can be a dynamic random accessing memory (DRAM) chip. A buffer device composed of the buffer 32 and the buffer manager 33, the medium access control units 31 and central processing unit 38 can be in another chip. Accordingly, the cost of performing the communication between the LAN and the WAN will be greatly reduced by organization the components of the gateway apparatus in one identical chips in the present invention and the regulation of transporting the packets between the LAN and the WAN will be more flexible for users to performed in actual transport situation.

While the invention has been described in terms of what are presently considered to be the most practical and preferred embodiments, it is to be understood that the invention needs not be limited to the disclose embodiments. On the contrary, it is tented to cover various modification and similar arrangements included within the spirit and scope of the appended claims which are be accorded with the broadest interpretation so as to encompass all such modifications and similar structure.

What we claim is:

1. A gateway apparatus for using in performing communication between wide area networks (WAN) to local area networks (LAN), comprising:
a plurality of input/output ports for connecting said WAN with said LAN;
a buffer device for accessing packets, wherein a transporting path of said packets is selected from one of sending said packets from said WAN to said LAN and sending said packets from said LAN to said WAN;
a plurality of medium access control units corresponding to said input/output ports and electrically connected between said buffer device and said input/output ports for performing an accessing operation between said buffer device and said input/output ports;
a memory device electrically connected to said buffer device for storing said packets sent from said buffer device; and
a central processing unit electrically connected between said memory device and said medium access control units for processing said packets stored in said memory device, and organizing said medium access control units to change said input/output ports according to a required transporting path, thereby performing said communication between said LAN and said WAN.

2. The gateway apparatus according to claim 1, wherein said buffer device comprises:
a buffer for temporally storing said packets; and
a buffer manager electrically connected to said buffer for managing an accessing operation of said buffer device.

3. The gateway apparatus according to claim 1, wherein said memory device comprises:
a memory for storing said packets sent from said buffer device; and
a memory controller electrically connected to said memory for controlling an accessing operation of said memory.

4. The gateway apparatus according to claim 3, wherein said memory is a dynamic random accessing memory (DRAM).

5. The gateway apparatus according to claim 3, further comprising:
an internal bus electrically connected to said memory controller for transporting said packets; and
a bus interface controller electrically connected between said buffer device and said internal bus for controlling a transporting operation in said internal bus so as to complete a packet transporting operation between said buffer device and said internal bus.

6. The gateway apparatus according to claim 1, wherein said buffer device, said medium access control units and said central processing unit are disposed in one identical chip.

7. The gateway apparatus according to claim 1, wherein said central processing unit is used for processing said packets stored in said memory device to achieve functions of a router and a firewall.
